(19) United States
(12) Patent Application Publication
(10) Pub. No.: US 2005/0199302 A1
(43) Pub. Date: Sep. 15, 2005

(54) Sequential valve

(76) Inventor: Tien-Fu Huang, Feng Yuan City (TW)

Correspondence Address: Tien-Fu Huang, PO Box 82-144, Taipei, TW

(21) Appl. No.: 10/796,070

(22) Filed: Mar. 10, 2004

(51) Int. Cl. F15B 13/042

(52) U.S. Cl. 137/625.66

(57) ABSTRACT

An improved structure of a sequential valve is disclosed. The valve comprising a body, valve sliding block cylinder A and cylinder B, piston B, piston A and a guiding cover, characterized in that the center portion of the body is provided with a vertical valve chamber to accommodate the valve sliding block, and the valve chamber passes through the cylinder A and the cylinder B, and the top edge of the valve chamber is stepped for the holding of the guiding cover; the top portion of the valve sliding block is a recessed air chamber and the bottom portion of the valve sliding block is an engaging slot so that the neck rim of the piston rod is positioned and within the interior of the valve chamber of the body; and the guiding cover is a flat plate provided with an air inlet hole, valve opening A, discharging opening and valve opening B, and is mounted onto the stepped position on the top face of the body and the bottom flat face is closely contact with the top flat face of the valve sliding block.

### BACKGROUND OF THE INVENTION

(a) Technical Field of the Invention

The present invention relates to a sequential valve structure, and in particular, improvements on valve body, valve, valve sliding block and guiding cover of a sequential valve.

(b) Description of the Prior Art

FIGS. 1 to 3 disclose a conventional sequential valve comprising a body 11, valve 12, end cover 13, pushing rod 14 and side cover 15. The body 11 is provided with a through cylinder 111 and the top face of the cylinder 111 is provided with an inlet A 112, air inlet B 113, valve opening A 114, air inlet path 115, 116, valve opening B 117 and air discharging opening. The valve 12 is positioned within the cylinder 111, and the two ends of the cylinder 111 are provided with an end cover 13 and a pushing rod 14, and the side cover 15 and a screw nut 16 are used for locking. The valve 12 is provided with two grooves 121, 122. The high pressurized air is introduced into the air inlet path 112 and the valve 12 is pushed to align to allow high pressure air to enter via the valve opening A and to the groove 121 till the air discharging opening 118. The other high pressure air is introduced via the air inlet B 116 via the groove 122 to valve opening B 117 for guiding out. After that, high air pressure is introduced from air inlet path B 115, and the valve 12 is pushed to align, and the high pressure air is introduced from the valve opening B 117 via the groove 121 and discharging via the air discharging opening 118. The other high pressure air is withdrawn via the air inlet opening A 113 via the groove 122 to the valve opening A 114 for discharging. Thus, rapid reciprocation of valve opening A 114 and valve opening B 117 provides high pressure to the machineries that needed. The drawback of such conventional valve is that the wall of the cylinder 111 has to make numbers of air inlet paths A 112, B 113, valve opening A 114, air inlet path B, air inlet hole B 116, valve opening B 117 and air discharging hole 118. The prolong and rapid reciprocating of plug 12 will damage the valve which causes leaks to the valve. Accordingly, it is an object of the present invention to provide an improved structure of a sequential valve which mitigates the above drawbacks.

### SUMMARY OF THE INVENTION

Accordingly, it is an object of the present invention to provide an improved structure of a sequential valve having a valve sliding block and a guiding cover, wherein the top flat face urges the bottom flat face so that the sealing effect is excellent.

Still another object of the present invention is to provide an improved structure of a sequential valve, wherein the external diameters of the valve A and valve B are different, the problem caused by similar pushing of dual direction pressure can be overcome, and therefore, the improved structure is reliable.

An aspect of the present invention is to provide an improved structure of a sequential valve comprising a body, valve sliding block, cylinder A and cylinder B, piston B, piston A and a guiding cover, characterized in that the center portion of the body is provided with a vertical valve chamber to accommodate the valve sliding block, and the valve chamber passes through the cylinder A and the cylinder B, and the top edge of the valve chamber is stepped for the holding of the guiding cover, the top portion of the valve sliding block is a recessed air chamber and the bottom portion of the valve sliding block is an engaging slot so that the neck rim of the piston rod is positioned and within the interior of the valve chamber of the body; and the guiding cover is a flat plate provided with an air inlet hole, valve opening A, discharging opening and valve opening B, and is mounted onto the stepped position on the top face of the body and the bottom flat face is closely contact with the top flat face of the valve sliding block.

Yet another object of the present invention is to provide an improved structure of a sequential valve, wherein external air is withdrawn to the cylinder A 211 and the cylinder B 215, vacuum suction generated at cylinder A 211 and cylinder B 212 is prevented such that the reciprocation movements of the piston A 32, the piston rod B 31, the piston B 35 and the valve sliding block 24 are smooth.

Still a further object of the present invention is to provide an improved structure of a sequential valve, wherein the valve sliding block 245 pushes to press the guiding cover 25 by the high pressure withdrawn via the air inlet hole 251 such that the valve is sealed with pressure.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view of a conventional valve.

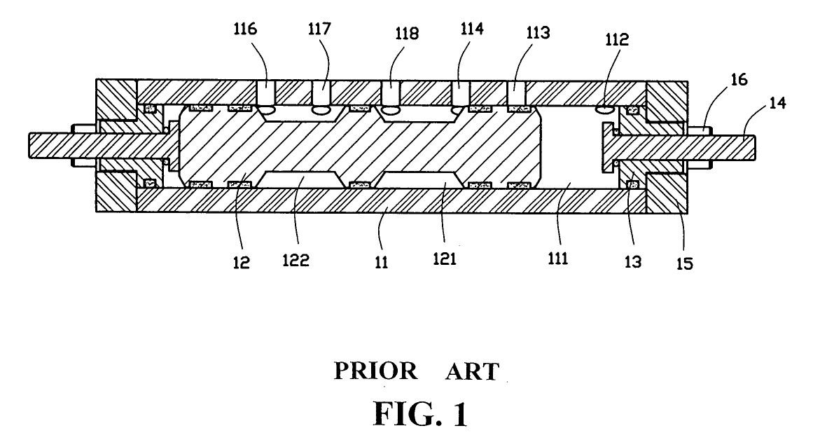

FIG. 2 is a schematic view showing the action of the conventional valve.

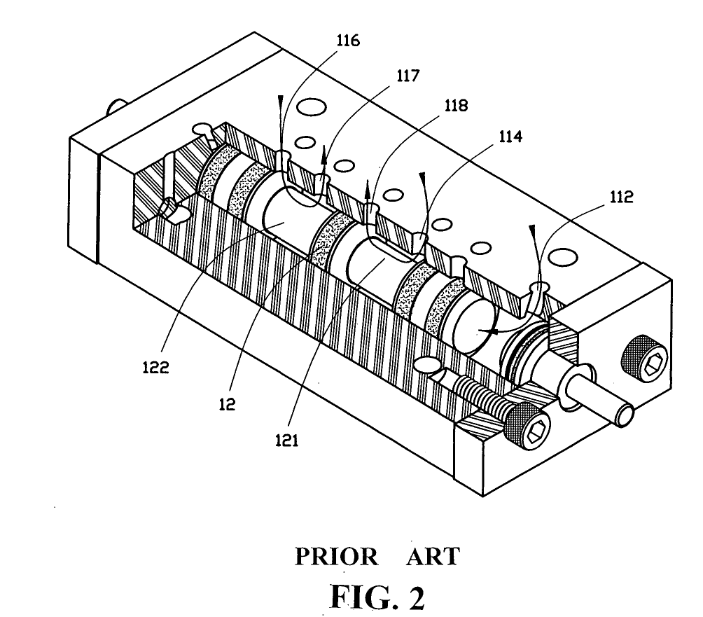

FIG. 3 is another schematic view showing the action of the conventional valve.

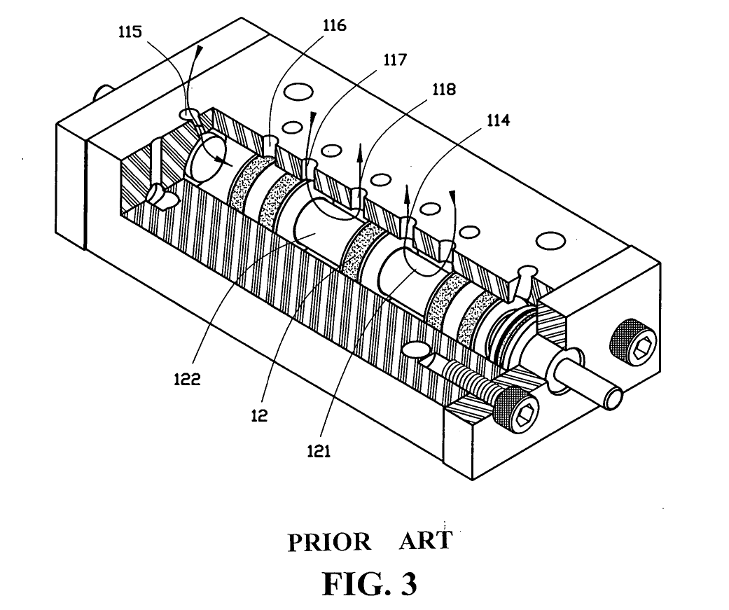

FIG. 4 is a perspective exploded view of an improved structure of a sequential valve of the present invention.

FIG. 5 is a sectional view of an improved structure of a sequential valve of the present invention.

FIG. 6 is a schematic view showing the action of the improved structure of the sequential valve of the present invention.

FIG. 7 is another schematic view showing the action of the improved structure of the sequential valve of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

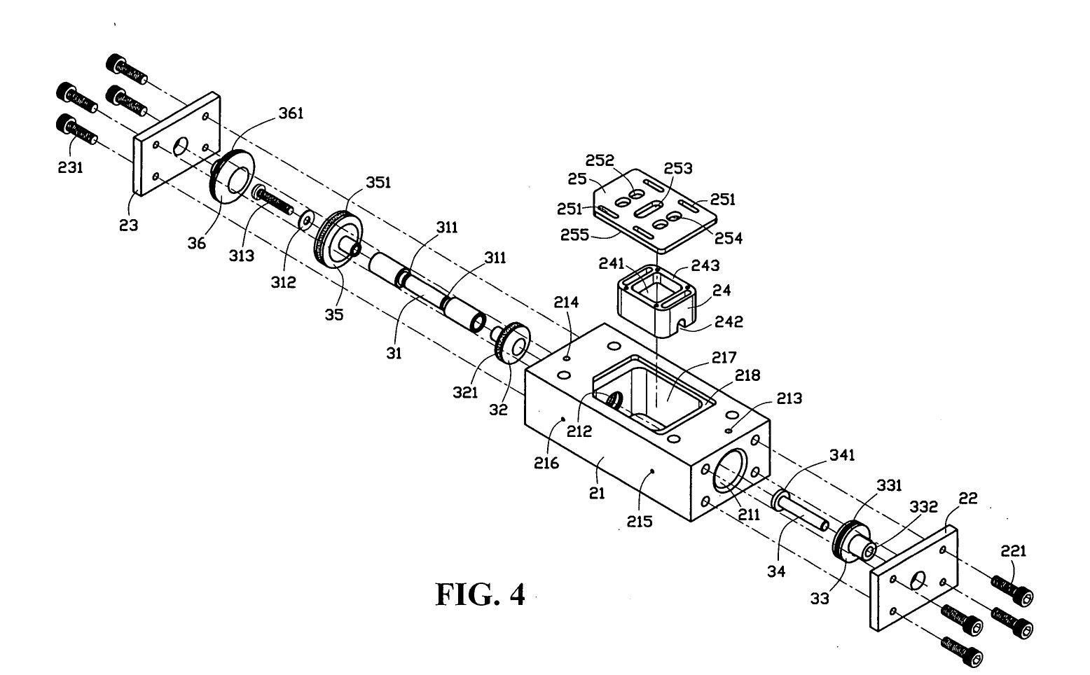

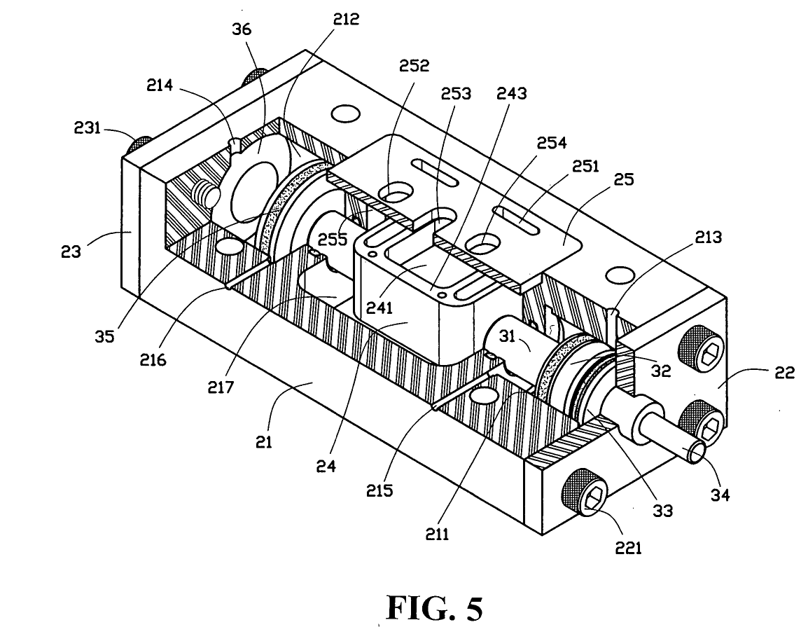

FIGS. 4 and 5 show a sequential valve comprising a body 21, a piston rod 31, piston A 32, an end cover A 33, a push rod 34, a side cover A 22, a piston B 35, an end cover B 36, a side cover B 23, the valve sliding block 24 and the guiding cover 25.

In accordance with the present invention, the body 21 is horizontally provided with a cylinder A 211 and a cylinder B 212. The cylinder A 211 and the cylinder B 212 are positioned on a same axial position. The top face of each cylinder A, B is provided respectively with an air inlet path A 213 passing through the cylinder A 211 and an air inlet path B 212 passing through the cylinder B 214. The cylinder A is radially provided with a through air path A 215, and the cylinder B is radially provided with a through air path B 216. The center portion is a vertical valve chamber 217 which passes through the cylinder A 211 and the cylinder B 212, and the top edge of the valve chamber 217 is a stepped structure 218.

The rod body of the piston rod 31 is provided with two recessed neck rim 311 and has one end for connection with the piston A 32 having a seal rim 321 at the outer edge thereof The other end of the piston rod 31 is for the connection with the piston B 35 having a seal rim 351 at the outer end thereof using a pad 312 and screw 313. The entire piston rod is sealed with the cylinder A 211 and the cylinder B 212 of the body 21, and the middle section of the two recessed neck rim 311 of the piston rod 31 is within the valve chamber 217.

The external diameter of the piston A 32 and the piston B 35 are pivotally mounted to the cylinder A 211 and the cylinder B 212 which is of the same size with respect to the external diameter.

The end cover A 33 has the same external diameter with that of the piston A 32. The center of the end cover A has a through hole 332 and the entire of the end cover A is close to the external side of the cylinder A 211.

The push rod 34 is pivotally mounted within the through hole 332 of the end cover A 33, and the end with a larger diameter 341 is positioned at the cylinder A 211 of the body 21 and the end with a smaller diameter is protruded out from the end cover A 33 and the side cover A 22.

Screw nut 221 is used to lock the side cover A 22 to the external side of the cylinder A 211, and the end with a smaller diameter of the end cover A 33 and the smaller diameter of the push rod 34 are exposed at the external side.

The end cover B 36 has an external diameter similar to that of the piston B 35, and the external edge of the end cover B 36 has a seal rim 361 and the entire end cover B 36 is positioned near to the external side of the cylinder B 212.

A screw nut 231 is used to lock the side cover B 23 to the external side of the cylinder B 212, and the end of the smaller diameter of the end cover B is exposed at the external side.

The top portion of the valve sliding block 24 is provided with a recessed air chamber 241 and the bottom section is an engaging slot 242. The engaging slot 242 is positioned at the neck rim 311 of the piston rod 31 so that the valve sliding block 24 is within the interior of the valve chamber 217.

The guiding cover 25 is a flat plate having an air inlet hole 251 valve opening A 252, an air discharge hole 253 and a valve opening B 254. The guiding cover 25 covers at the stepped structure 218 at the top face of the body 21, and the bottom flat face 255 urges closely to the top flat face 243 of the valve sliding block 24. In accordance with the present invention, the switching of high pressure air is as follows:

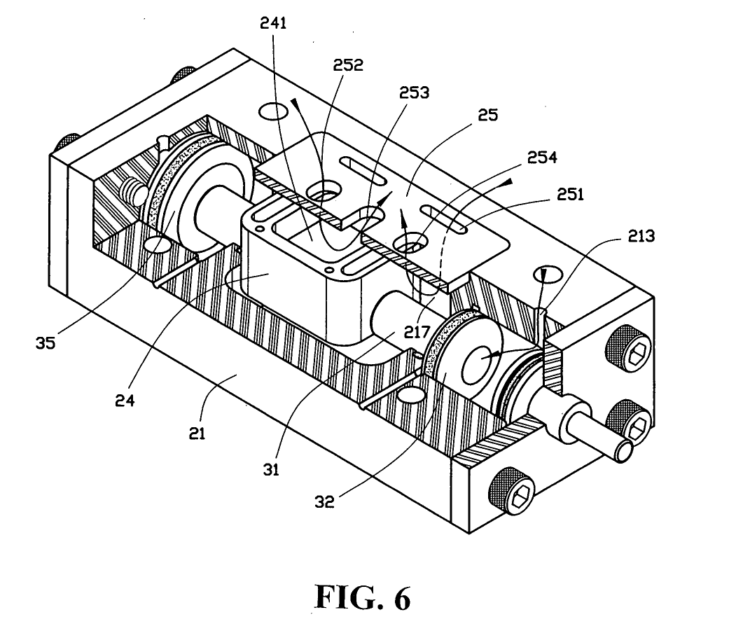

Referring to FIG. 6, high air pressure is withdrawn via the air inlet path A 213 and the piston A 32, piston rod 31, piston B 35 and the valve sliding block 24 are pushed to that direction so that the high pressure air enters via the valve opening A and via the air chamber 241 to the center discharge hole 253 for discharging. At this instance, another high pressure air enters via the air inlet hole 251 at the two sides thereof, via the valve chamber 217 to the valve opening B 254.

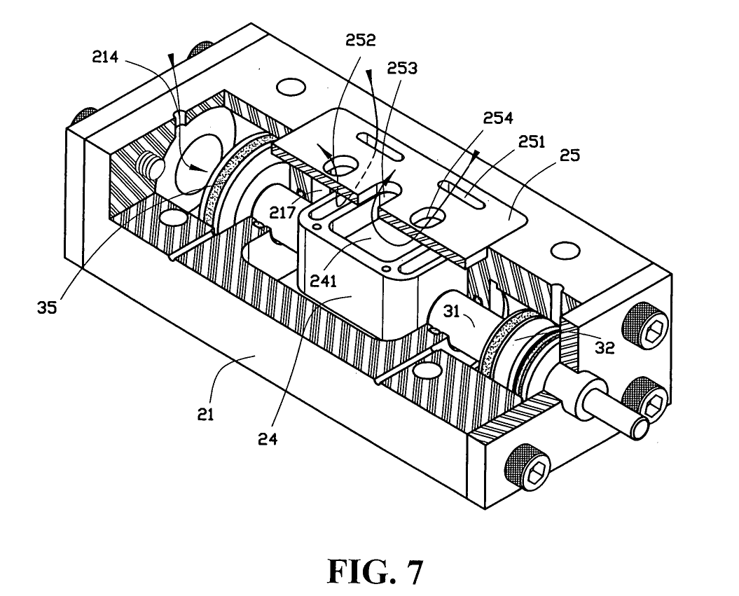

In other words, valve opening A 252 and the air discharging hole 253 are formed into a high pressure air path and the air inlet opening 251 and the valve opening B 254 are formed into another high pressure air path. Referring to FIG. 7, high pressure air is withdrawn via the air inlet path B 214 and the piston B 35, the piston rod 31, the piston A 32 and the valve sliding block 24 are pushed in that direction such that a high pressure air can be delivered via the valve opening B 254 and via the air chamber 241 to the center air discharging hole 253. At this point, another high pressure is introduced via the air inlet hole 252 at the side of the body 21 and is discharged via the valve opening A 252. In another words, the valve opening B 254 and the air discharging opening 253 are formed into a high air pressure path; and the air inlet hole 251 and the valve opening A 252 are formed into another high pressure air path.

In view of the above, high pressure air is subsequently swifted from the valve opening A 252 to the valve opening B 254 so as to proceed with the shifting for use in other devices or machineries.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An improved structure of a sequential valve comprising a body, valve sliding block, cylinder A and cylinder B, piston B, piston A and a guiding cover, characterized in that the center portion of the body is provided with a vertical valve chamber to accommodate the valve sliding block, and the valve chamber passes through the cylinder A and the cylinder B, and the top edge of the valve chamber is stepped for the holding of the guiding cover; the top portion of the valve sliding block is a recessed air chamber and the bottom portion of the valve sliding block is an engaging slot so that the neck rim of the piston rod is positioned and within the interior of the valve chamber of the body; and the guiding cover is a flat plate provided with an air inlet hole, valve opening A, discharging opening and valve opening B, and is mounted onto the stepped position on the top face of the body and the bottom flat face is closely contact with the top flat face of the valve sliding block.

2. The improved structure of a sequential valve according to claim 1, wherein the piston rod is provided with two recessed neck rim for the engagement of the valve sliding block.

3. The improved structure of a sequential valve according to claim 1, wherein the external diameters of the piston A and piston B are different and the piston A and piston B are respectively pivotally mounted to the cylinder A and cylinder B of similar external diameter.

4. The improved structure of a sequential valve according to claim 1, wherein the cylinder A is radially provided with a through air path A and the cylinder B is radially provided with a through air path B.
